(19) United States
(12) Patent Application Publication
(10) Pub. No.: US 2012/0058271 A1
(43) Pub. Date: Mar. 8, 2012

(54) TRANSPARENT INK-JET RECORDING FILMS, COMPOSITIONS, AND METHODS

(76) Inventors: Sharon M. Simpson, Lake Elmo, MN (US); James R. Wagner, Stillwater, MN (US); James L. Johnston, Brighton, CO (US)

(21) Appl. No.: 13/204,784

(22) Filed: Aug. 8, 2011

Related U.S. Application Data
(60) Provisional application No. 61/379,856, filed on Sep. 3, 2010.

(51) Int. Cl. B05D 1/36; B05D 5/00; B41M 5/42

(52) U.S. Cl. 427/256; 427/407.1; 428/32.1

(57) ABSTRACT

Transparent ink jet recording films, compositions, and methods are disclosed. These films exhibit high maximum optical densities and low haze values. Such films are useful for medical imaging.

### CROSS REFERENCE TO RELATED APPLICATIONS

This application claims the benefit of U.S. Provisional Application No. 61/379,856, filed Sep. 3, 2010, which is hereby incorporated by reference in its entirety.

### BACKGROUND

Transparent ink-jet recording films typically employ one or more image-receiving layers on which ink is deposited during the ink-jet printing process. In some embodiments, such image-receiving layers may comprise polymeric binders and inorganic particles, such as, for example, boehmite alumina. In order to obtain high image densities when printing on transparent films, more ink is often applied during the ink-jet printing process than is required for opaque films. To be able to accommodate more printing ink, image-receiving layer thicknesses can be increased relative to those in opaque films. However, such a change generally increases the amount of water or organic solvents that must be removed from the wet image-receiving layers during the film drying portion of the manufacturing process. Moving to more aggressive drying conditions to compensate can cause undesirable patterns to form on the film; however, use of mild drying conditions can adversely impact process throughput. Unfortunately, moving to higher solids coating mixes to reduce the amount of liquid to be removed by drying can entail handling high viscosity slurries with the risk of gelation during process upsets.

U.S. Pat. No. 4,186,178 to Oberlander, which is hereby incorporated by reference in its entirety, discloses that increasing alumina concentration in dispersions increases their tendency to gel. Treatment of dispersions with acid can improve dispersibility, but use of excessive acid can cause gelation. Oberlander discloses treating alumina with hot water and acidifying to improve dispersion stability. Dispersions with pHs from 4.06 to 4.36 are disclosed.

U.S. Pat. No. 4,676,928 to Leach et al., which is hereby incorporated by reference in its entirety, discloses alumina dispersions with pH from about 2 to about 4. However, Leach et al. maintain that such low pH dispersions are corrosive and that the properties of such low pH dispersions can be variable because of their sensitivity to the presence of impurities. Leach et al. disclose adding sufficient acid to alumina slurries of pH greater than 9 to lower their pH to about 5, heating to form a colloidal sol with pH greater than about 4, and recovering water-dispersible alumina from the sol.

A Sasol technical bulletin, DISPERAL®/DISPAL® High Purity Dispersible Aluminas, 2003, and a Sasol technical presentation, Inorganic Specialty Chemicals, 2005, each of which is hereby incorporated by reference in its entirety, disclose that alumina dispersions flocculate at pHs near 7 and that dispersion viscosities exhibit two minima at pHs of about 4 and about 10. Dispersion viscosities are shown to increase over several orders of magnitude as pH decreases below about 4. The presentation indicates that use of dispersion pHs below 2 may cause gelation. The presentation also discloses adding alumina to deionized water, acidifying, heating to 80 C with stirring, separating non-dispersed particles, optionally adding acid to control pH, adding a binder, and either avoiding gel-promoting cationic additives or adding them just prior to coating.

### SUMMARY

Transparent ink jet recording films often employ one or more image-receiving layers on one or both sides of a transparent support. In order to obtain high image densities when printing on transparent films, more ink is often applied than is required for opaque films. To be able to accommodate more printing ink, image-receiving layer thicknesses can be increased relative to those in opaque films. The compositions and methods of the present application can provide transparent ink jet recording films with increased image-receiving layer thicknesses. Such films can exhibit high maximum optical densities and low haze values.

One embodiment provides a method comprising providing a first composition comprising alumina, nitric acid, and water, with the first composition comprising at least about 25 wt % alumina and having a pH below about 3.09; forming an alumina mix according to a method comprising heating the first composition; and forming an image-receiving layer from a second composition comprising said alumina mix and at least one first water soluble or water dispersible polymer. The alumina may, in some cases, comprise boehmite alumina. The at least one first water soluble or water dispersible polymer may comprise, for example, poly(vinyl alcohol). In some embodiments, the first composition may comprise at least about 30 wt % alumina. In some embodiments, the pH may be below about 2.73, or may be, for example, between about 2.17 and about 2.73. In some embodiments, the alumina mix may comprise at least about 25 wt % solids or at least about 30 wt % solids. In some cases, heating the first composition may comprise heating the first composition to at least about 80° C.

In some embodiments, the method further comprises forming an under-layer from a third composition, which comprises at least one second water soluble or water dispersible polymer and a borate or borate derivative. The first polymer and second polymer may be the same type of polymer or may be different types of polymers. In some cases, the second polymer may comprise poly(vinyl alcohol). In some cases, the borate or borate derivative may comprise borax.

Another embodiment provides a transparent ink-jet recording film comprising the ink-jet image-receiving layer formed according to these and other embodiments. Such image-receiving layers may have dry coating weights of, for example, at least about 40 g/m² on a dry basis, or at least about 41.0 g/m² on a dry basis, or at least about 43 g/m² on a dry basis, or at least about 44 g/m² on a dry basis, or at least about 50 g/m² on a dry basis. Such ink-jet recording films may further comprise an under-layer formed from a third composition, which comprises a second water soluble or water dispersible polymer and a borate or borate derivative. Such an under-layer may, for example, comprise at least about 2.9 g/m² on a dry basis, or at least about 3.0 g/m² on a dry basis, or at least about 3.5 g/m² on a dry basis, or at least about 4.0 g/m² on a dry basis, or at least about 4.2 g/m² on a dry basis. The first polymer and second polymer may be the same type of polymer or may be different types of polymers. In some cases, the second polymer may comprise poly(vinyl alcohol). In some cases, the borate or borate derivative may comprise borax. Such ink-jet recording films may have maximum optical densities of, for example, at least about 2.8. Such films may have haze values of, for example, below about 24, or below about 23, or below about 19, or below about 16.

Also provided are methods comprising printing on the transparent ink jet recording film according to these and other embodiments.

These embodiments and other variations and modifications may be better understood from the detailed description, exemplary embodiments, examples, and claims that follow. Any embodiments provided are given only by way of illustrative example. Other desirable objectives and advantages inherently achieved may occur or become apparent to those skilled in the art. The invention is defined by the appended claims.

### DETAILED DESCRIPTION

All publications, patents, and patent documents referred to in this document are incorporated by reference herein in their entirety, as though individually incorporated by reference.

U.S. Provisional Application No. 61/379,856, filed Sep. 3, 2010, is hereby incorporated by reference in its entirety.

### Introduction

An ink-jet recording film may comprise at least one image-receiving layer, which receives ink from an ink jet printer during printing, and a substrate or support, which may be opaque or transparent. An opaque support may be used in films that may be viewed using light reflected by a reflective backing, while a transparent support may be used in films that may be viewed using light transmitted through the film.

Some medical imaging applications require high image densities. For a reflective film, high image densities may be achieved by virtue of the light being absorbed on both its path into the imaged film and again on the light's path back out of the imaged film from the reflective backing. On the other hand, for a transparent film, because of the lack of a reflective backing, achievement of high image densities may require application of larger quantities of ink than are common for opaque films. In such cases, larger quantities of liquids must generally be removed while drying transparent films during their manufacture, which can impact the both the quality of the dried film and the throughput of the drying process.

### Transparent Ink-Jet Films

Transparent ink-jet recording films are known in the art. See, for example, U.S. patent application Ser. No. 13/176,788, “TRANSPARENT INK-JET RECORDING FILM,” by Simpson et al., filed Jul. 6, 2011, and U.S. Provisional Patent Application No. 61/375,325, “SMUDGE RESISTANCE OF MATTE BLANK INKS AND DRYING OF INKS USING A 2-LAYER INKJET RECEPTOR CONTAINING A MONOSACCHARIDE OR DISACCHARIDE ON A TRANSPARENT SUPPORT,” by Simpson et al., filed Aug. 20, 2010, both of which are hereby incorporated by reference in their entirety.

Transparent ink-jet recording films may comprise one or more transparent substrates upon which at least one under-layer may be coated. Such an under-layer may optionally be dried before being further processed. The film may further comprise one or more image-receiving layers coated upon at least one under-layer. Such an image-receiving layer is generally dried after coating. The film may optionally further comprise additional layers, such as one or more primer layers, subbing layers, backing layers, or overcoat layers, as will be understood by one skilled in the art.

### Under-Layer Coating Mix

Under-layers may be formed by applying at least one under-layer coating mix to one or more transparent substrates. The under-layer coating mix may comprise at least one water soluble or dispersible cross-linkable polymer comprising at least one hydroxyl group, such as, for example, poly(vinyl alcohol), partially hydrolyzed poly(vinyl acetate/vinyl alcohol), copolymers containing hydroxyethylmethacrylate, copolymers containing hydroxyethylacrylate, copolymers containing hydroxypropylmethacrylate, hydroxy cellulose ethers, such as, for example, hydroxyethylcellulose, and the like. More than one type of water soluble or water dispersible cross-linkable polymer may optionally be included in the under-layer coating mix. In some embodiments, the water soluble or water dispersible polymer may be used in an amount of, for example, from about 0.25 to about 2.0 g/m², or from about 0.02 to about 1.8 g/m², as measured in the under-layer.

The under-layer coating mix may also optionally comprise at least one borate or borate derivative, such as, for example, sodium borate, sodium tetraborate, sodium tetraborate decahydrate, boric acid, phenyl boronic acid, butyl boronic acid, and the like. More than one type of borate or borate derivative may optionally be included in the under-layer coating mix. In some embodiments, the borate or borate derivative may be used in an amount of up to about 2 g/m². In at least some embodiments, the ratio of the at least one borate or borate derivative to the at least one water soluble or water dispersible polymer may be, for example, between about 25:75 and about 90:10 by weight, or the ratio may be about 66:33 by weight.

The under-layer coating mix may also optionally comprise other components, such as surfactants, such as, for example, nonyl phenol, glycidyl polyether. In some embodiments, such a surfactant may be used in amount from about 0.001 to about 0.10 g/m², as measured in the under-layer. These and other optional mix components will be understood by those skilled in the art.

### Image-Receiving Layer Coating Mix

Image-receiving layers may be formed by applying at least one image-receiving layer coating mix to one or more under-layer coatings. The image-receiving layer formed may, in some cases, comprise at least about 40 g/m² on a dry basis, or at least about 41.0 g/m² on a dry basis, or at least about 43 g/m² on a dry basis, or at least about 44 g/m² on a dry basis, or at least about 50 g/m² on a dry basis. The image-receiving coating mix may comprise at least one water soluble or dispersible cross-linkable polymer comprising at least one hydroxyl group, such as, for example, poly(vinyl alcohol), partially hydrolyzed poly(vinyl acetate/vinyl alcohol), copolymers containing hydroxyethylmethacrylate, copolymers containing hydroxyethylacrylate, copolymers containing hydroxypropylmethacrylate, hydroxy cellulose ethers, such as, for example, hydroxyethylcellulose, and the like. More than one type of water soluble or water dispersible cross-linkable polymer may optionally be included in the under-layer coating mix. In some embodiments, the at least one water soluble or water dispersible polymer may be used in an amount of up to about 1.0 to about 4.5 g/m², as measured in the image-receiving layer.

The image-receiving layer coating mix may also comprise at least one inorganic particle, such as, for example, metal oxides, hydrated metal oxides, boehmite alumina, clay, calcined clay, calcium carbonate, aluminosilicates, zeolites, barium sulfate, and the like. Non-limiting examples of inorganic particles include silica, alumina, zirconia, and titania. Other non-limiting examples of inorganic particles include fumed silica, fumed alumina, and colloidal silica. In some embodiments, fumed silica or fumed alumina have primary particle sizes up to about 50 nm in diameter, with aggregates being less than about 300 nm in diameter, for example, aggregates of about 160 nm in diameter. In some embodiments, colloidal silica or boehmite alumina have particle size less than about 15 nm in diameter, such as, for example, 14 nm in diameter. More than one type of inorganic particle may optionally be included in the image-receiving coating mix.

In at least some embodiments, the ratio of inorganic particles to polymer in the at least one image-receiving layer coating mix may be, for example, between about 88:12 and about 95:5 by weight, or between about 90:10 and about 95:5 by weight, or the ratio may be about 92:8 by weight.

Image-receiving layer coating layer mixes prepared from alumina mixes with higher solids fractions can perform well in this application. However, high solids alumina mixes can, in general, become too viscous to be processed. It has been discovered that suitable alumina mixes can be prepared at, for example, 25 wt % or 30 wt % solids, where such mixes comprise alumina, nitric acid, and water, and where such mixes comprise a pH below about 3.09, or below about 2.73, or between about 2.17 and about 2.73. During preparation, such alumina mixes may optionally be heated, for example, to 80° C.

The image-receiving coating layer mix may also comprise one or more surfactants such as, for example, nonyl phenol, glycidyl polyether. In some embodiments, such a surfactant may be used in amount of, for example, about 1.5 g/m², as measured in the image-receiving layer. In some embodiments, the image-receiving coating layer mix may also optionally comprise one or more acids, such as, for example, nitric acid.

These and other components may optionally be included in the image-receiving coating layer mix, as will be understood by those skilled in the art.

### Transparent Substrate

Transparent substrates may be flexible, transparent films made from polymeric materials, such as, for example, polyethylene terephthalate, polyethylene naphthalate, cellulose acetate, other cellulose esters, polyvinyl acetal, polyolefins, polycarbonates, polystyrenes, and the like. In some embodiments, polymeric materials exhibiting good dimensional stability may be used, such as, for example, polyethylene terephthalate, polyethylene naphthalate, other polyesters, or polycarbonates.

Other examples of transparent substrates are transparent, multilayer polymeric supports, such as those described in U.S. Pat. No. 6,630,283 to Simpson, et al., which is hereby incorporated by reference in its entirety. Still other examples of transparent supports are those comprising dichroic mirror layers, such as those described in U.S. Pat. No. 5,795,708 to Boutet, which is hereby incorporated by reference in its entirety.

Transparent substrates may optionally contain colorants, pigments, dyes, and the like, to provide various background colors and tones for the image. For example, a blue tinting dye is commonly used in some medical imaging applications. These and other components may be included in the transparent substrate, as will be understood by those skilled in the art.

In some embodiments, the transparent substrate may be provided as a continuous or semi-continuous web, which travels past the various coating, drying, and cutting stations in a continuous or semi-continuous process.

### Coating

The at least one under-layer and at least one image-receiving layer may be coated from mixes onto the transparent substrate. The various mixes may use the same or different solvents, such as, for example, water or organic solvents. Layers may be coated one at a time, or two or more layers may be coated simultaneously. For example, simultaneously with application of an under-layer coating mix to the support, an image-receiving layer may be applied to the wet under-layer using such methods as, for example, slide coating.

Layers may be coated using any suitable methods, including, for example, dip-coating, wound-wire rod coating, doctor blade coating, air knife coating, gravure roll coating, reverse-roll coating, slide coating, bead coating, extrusion coating, curtain coating, and the like. Examples of some coating methods are described in, for example, Research Disclosure, No. 308119, December 1989, pp. 1007-08, (available from Research Disclosure, 145 Main St., Ossining, N.Y., 10562, http://www.researchdisclosure.com).

### Drying

Coated layers, such as, for example under-layers or image-receiving layers, may be dried using a variety of known methods. Examples of some drying methods are described in, for example, Research Disclosure, No. 308119, December 1989, pp. 1007-08, (available from Research Disclosure, 145 Main St., Ossining, N.Y., 10562, http://www.researchdisclosure.com). In some embodiments, coating layers may be dried as they travel past one or more perforated plates through which a gas, such as, for example, air or nitrogen, passes. Such an impingement air dryer is described in U.S. Pat. No. 4,365,423 to Arter et al., which is incorporated by reference in its entirety. The perforated plates in such a dryer may comprise perforations, such as, for example, holes, slots, nozzles, and the like. The flow rate of gas through the perforated plates may be indicated by the differential gas pressure across the plates. The ability of the gas to remove water may be limited by its dew point, while its ability to remove organic solvents may be limited by the amount of such solvents in the gas, as will be understood by those skilled in the art.

In some embodiments, the under-layer may be dried by exposure to ambient air. Image-receiving layers may be dried by exposure to air at, for example, 85° C. for 10 min in a Blue M Oven.

### EXEMPLARY EMBODIMENTS

U.S. Provisional Application No. 61/379,856, filed Sep. 3, 2010, which is hereby incorporated by reference in its entirety, disclosed the following fourteen non-limiting exemplary embodiments:

A. A method comprising:
providing a first composition comprising alumina, nitric acid, and water, said first composition comprising at least about 25 wt % alumina and comprising a pH below about 3.09;
forming an alumina mix according to a method comprising heating the first composition; and
forming an image-receiving layer from a second composition comprising said alumina mix and at least one first water soluble or water dispersible polymer.

The method according to embodiment A, further comprising forming an under-layer from a third composition comprising at least one second water soluble or water dispersible polymer and a borate or borate derivative.

C. The method according to embodiment B, wherein said at least one second water soluble or water dispersible polymer comprises poly(vinyl alcohol).

D. The method according to embodiment A, wherein said at least one first water soluble or water dispersible polymer comprises poly(vinyl alcohol).

E. The method according to embodiment A, wherein said first composition comprises at least about 30 wt % alumina.

F. The method according to embodiment A, wherein said pH is below about 2.73.

G. The method according to embodiment A, wherein said pH is between about 2.17 and about 2.73.

H. The method according to embodiment A, wherein the alumina mix comprises at least about 25 wt % solids.

I. The method according to embodiment A, wherein the alumina mix comprises at least about 30 wt % solids.

J. The method according to embodiment A, wherein said heating the first composition comprises heating the first composition to about 80° C.

K. A transparent ink-jet recording film comprising the image-receiving layer formed according to the method of embodiment A.

L. The transparent ink-jet recording film of embodiment K, further comprising an under-layer formed from a third composition comprising a second water soluble or water dispersible polymer and a borate or borate derivative.

M. The transparent ink-jet recording film of embodiment L, wherein said at least one second water soluble or water dispersible polymer comprises poly(vinyl alcohol).

N. A method comprising printing on the transparent ink-jet recording film according to embodiment K.

### EXAMPLES

### Materials

Materials used in the examples were available from Aldrich Chemical Co., Milwaukee, unless otherwise specified.

Boehmite is an aluminum oxide hydroxide (γ-AlO(OH)).

Borax is sodium tetraborate decahydrate.

CELVOL® 203 is a poly(vinyl alcohol) that is 87-89% hydrolyzed, with 13,000-23,000 weight-average molecular weight. It is available from Sekisui Specialty Chemicals America, LLC, Dallas, Tex.

CELVOL® 540 is a poly(vinyl alcohol) that is 87-89.9% hydrolyzed, with 140,000-186,000 weight-average molecular weight. It is available from Sekisui Specialty Chemicals America, LLC, Dallas, Tex.

DISPERAL® HP-14 is a dispersible boehmite alumina powder with high porosity and a particle size of 140 nm. It is available from Sasol North America, Inc., Houston, Tex.

Surfactant 10G is an aqueous solution of nonyl phenol, glycidyl polyether. It is available from Dixie Chemical Co., Houston, Tex.

### Methods

Coated films were imaged with an EPSON® 7900 ink jet printer using a Wasatch Raster Image Processor (RIP). A grey scale image was created by a combination of photo black, light black, light light black, magenta, light magenta, cyan, light cyan, and yellow EPSON® inks that were supplied with the printer. Samples were printed with a 17-step grey scale wedge having a maximum optical density of at least 2.8.

Immediately after the film exited the printer, the ink jet image was turned over and placed over a piece of white paper. The percent of wet ink on the step having the maximum density (“wetness value”) was graded on a scale of 0 (completely dry) to 100 (completely wet).

The optical density of each coated film was measured using a calibrated X-RITE® Model DTP 41 Spectrophotometer (X-Rite, Inc., Grandville, Mich.) in transmission mode.

Haze (%) was measured in accord with ASTM D 1003 by conventional means using a HAZE-GARD PLUS Hazemeter, available from BYK-Gardner (Columbia, Md.).

### Example 1 (Comparative)

A nominal 20 wt % alumina mix was prepared at room temperature by mixing 4.62 g of a 22 wt % aqueous solution of nitric acid and 555.38 g of deionized water. To this mix, 140 g of alumina powder (DISPERAL® HP-14) was added over 30 min. The pH of the mix was adjusted to 3.25 by adding nitric acid solution. The mix was heated to 80° C. and stirred for 30 min. The mix was cooled to room temperature and held for gas bubble disengagement prior to use.

A nominal 18 wt % solids image-receiving coating mix was prepared at room temperature by adding 7.13 g of a 10 wt % aqueous solution of poly(vinyl alcohol) (CELVOL® 540) and 1.00 g deionized water. To this mix, 41.00 g of the nominal 20 wt % alumina mix and 0.66 g of a 10 wt % aqueous solution of nonyl phenol, glycidyl polyether (Surfactant 10G) was added. The resulting mix had an inorganic particle to polymer weight ratio of 92:8. The mix was cooled to room temperature and held for gas bubble disengagement prior to use.

An under-layer coated substrate was prepared as follows. An under-layer coating mix was prepared using a 15 wt % aqueous solution of poly(vinyl alcohol) (CELVOL® 203) and a 5 wt % aqueous solution of borax. A 7 mil polyethylene terephthalate substrate was knife-coated at room temperature with a mixture of 1.24 g of the poly(vinyl alcohol) solution, 7.47 g of the borax solution, and 5.29 g of deionized water, using a wet coating gap of 4 mils. The resulting under-layer coating had 4 wt % solids and a weight ratio of borax to polymer of 66:33. The under-layer coating was air-dried at room temperature. The dry under-layer coating weight was 1.44 g/m².

The nominal 18 wt % solids image-receiving layer coating mix was knife-coated at room temperature onto the under-layer coated substrate, using a coating gap of 12 mils. The coated film was dried at 85° C. for 10 min in a Blue M Oven. The dry image-receiving layer coating weight was 43 g/m².

The coated film was evaluated as described above. The coated film had a maximum optical density of 2.788 and the first wedge was 50% wet. The haze value was 23.6%, as measured on a blue-tinted support.

### Example 2 (Comparative)

A nominal 25 wt % alumina mix was prepared at room temperature by mixing 5.78 g of a 22 wt % aqueous solution of nitric acid and 519.22 g of deionized water. To this mix, 175 g of alumina powder (DISPERAL® HP-14) was added over 30 min. The pH of the mix was 3.09. The mix was heated to 80° C. and stirred for 30 min. The mix was cooled to room temperature and held for gas bubble disengagement prior to use. The mix was characterized as being very viscous and unsuitable for use in knife-coating.

### Example 3

A nominal 25 wt % alumina mix was prepared at room temperature by mixing 9.01 g of a 22 wt % aqueous solution of nitric acid and 515.99 g of deionized water. To this mix, 175 g of alumina powder (DISPERAL® HP-14) was added over 30 min. The pH of the mix was 2.73. The mix was heated to 80° C. and stirred for 30 min. The mix was cooled to room temperature and held for gas bubble disengagement prior to use. This mix was much less viscous than the alumina mix of Example 2.

A nominal 22 wt % solids image-receiving coating mix was prepared at room temperature by mixing 8.75 g of a 10 wt % aqueous solution of poly(vinyl alcohol) (CELVOL® 540), 40.25 g of the nominal 25 wt % alumina mix, and 0.81 g of a 10 wt % aqueous solution of nonyl phenol, glycidyl polyether (Surfactant 10G). The mix was cooled to room temperature and held for gas bubble disengagement prior to use.

An under-layer coated substrate was prepared as in Example 1. The nominal 22 wt % solids image-receiving layer coating mix was knife-coated at room temperature onto the under-layer coated substrate, using a coating gap of 9.8 mils. The coated film was dried at 85° C. for 10 min in a Blue M Oven. The dry image-receiving layer coating weight was 43.3 g/m².

The coated film was evaluated as described above. The coated film had a maximum optical density of 2.905 and the first wedge was 25% wet. The haze value was 23.1%.

### Example 4

A nominal 30 wt % alumina mix was prepared at room temperature by mixing 13.65 g of a 22 wt % aqueous solution of nitric acid and 476.35 g of deionized water. To this mix, 210 g of alumina powder (DISPERAL® HP-14) was added over 30 min. The pH of the mix was 2.45. The mix was heated to 80° C. and stirred for 30 min. The mix was cooled to room temperature and held for gas bubble disengagement prior to use.

A nominal 26 wt % solids image-receiving coating mix was prepared at room temperature by mixing 10.11 g of a 10 wt % aqueous solution of poly(vinyl alcohol) (CELVOL® 540), 38.75 g of the nominal 30 wt % alumina mix, and 0.94 g of a 10 wt % aqueous solution of nonyl phenol, glycidyl polyether (Surfactant 10G). The mix was cooled to room temperature and held for gas bubble disengagement prior to use.

An under-layer coated substrates was prepared as in Example 1. The nominal 26 wt % solids image-receiving layer coating mix was knife-coated at room temperature onto the under-layer coated substrate, using a coating gap of 8.5 mils. The coated film was dried at 85° C. for 10 min in a Blue M Oven. The dry image-receiving layer coating weight was 44.8 g/m².

The coated film was evaluated as described above. The coated film had a maximum optical density of 2.880 and the first wedge was 12.5% wet. The haze value was 21.8%.

### Example 5

A nominal 30 wt % alumina mix was prepared at room temperature by mixing 15.75 g of a 22 wt % aqueous solution of nitric acid and 474.25 g of deionized water. To this mix, 210 g of alumina powder (DISPERAL® HP-14) was added over 30 min. The pH of the mix was 2.13. The mix was heated to 80° C. and stirred for 30 min. The mix was cooled to room temperature and held for gas bubble disengagement prior to use.

A nominal 26 wt % solids image-receiving coating mix was prepared at room temperature by mixing 10.11 g of a 10 wt % aqueous solution of poly(vinyl alcohol) (CELVOL® 540), 38.75 g of the nominal 30 wt % alumina mix, and 0.94 g of a 10 wt % aqueous solution of nonyl phenol, glycidyl polyether (Surfactant 10G). The mix was cooled to room temperature and held for gas bubble disengagement prior to use.

An under-layer coated substrate was prepared as in Example 1. The nominal 26 wt % solids image-receiving layer coating mix was knife-coated at room temperature onto the under-layer coated substrate, using a coating gap of 8.5 mils. The coated film was dried at 85° C. for 10 min in a Blue M Oven. The dry image-receiving layer coating weight was 44.8 g/m².

The coated film was evaluated as described above. The coated film had a maximum optical density of 2.978 and the first wedge was 75% wet. The haze value was 21.6%.

### Example 6 (Comparative)

The procedure of Example 1 was replicated. The resulting coated film had a maximum optical density of 2.976 and the first wedge was 100% wet. The haze value was 23.7%.

### Example 7

The procedure of Example 3 was replicated. The resulting coated film had a maximum optical density of 2.978 and the first wedge was 50% wet. The haze value was 22.3%.

### Example 8

The procedure of Example 4 was replicated. The resulting coated film had a maximum optical density of 2.931 and the first wedge was 100% wet. The haze value was 21.4%.

### Example 9 (Comparative)

A nominal 20 wt % alumina mix was prepared at room temperature by mixing 94 g of a 22 wt % aqueous solution of nitric acid and 6706 g of deionized water. To this mix, 1700 g of alumina powder (DISPERAL® HP-14) was added over 30 min. The pH of the mix was adjusted to 3.25 by adding an additional 21 g of the nitric acid solution. The mix was heated to 80° C. and stirred for 30 min. The mix was cooled to room temperature and held for gas bubble disengagement prior to use. The cooled mix had a pH of 3.60.

A nominal 18 wt % solids image-receiving coating mix was prepared at room temperature by adding 1432 g of a 10 wt % aqueous solution of poly(vinyl alcohol) (CELVOL® 540) and 202 g deionized water. To this mix, 8234 g of the nominal 20 wt % alumina mix and 133 g of a 10 wt % aqueous solution of nonyl phenol, glycidyl polyether (Surfactant 10G) was added. The mix was cooled to room temperature and held for gas bubble disengagement prior to use. The image-receiving coating mix had a viscosity of 21 cP at 40° C.

An under-layer coated web was prepared as follows. An under-layer coating mix was prepared using a 15 wt % aqueous solution of poly(vinyl alcohol) (CELVOL® 203) and a 5 wt % aqueous solution of borax. The ratio of borax to poly(vinyl alcohol) in the resulting under-layer coating mix was 66:33 by weight. This mix was heated to 40° C. and was applied continuously at a rate of 23.2 g/min to a clear room temperature polyethylene terephthalate web, which was moving at a speed of 30 ft/min. The coated web was dried continuously by moving past perforated plates through which room temperature air flowed. The pressure drops across the perforated plates were in the range of 0.8 to 3 in H₂O. The air dew point ranged from 7 to 13 C. The resulting dry under-coating weight was 0.67 g/m².

The image-receiving layer coating mix was heated to 40° C. and was applied continuously at rates of 113, 170, and 227 g/min onto the under-layer coated web, which was at room temperature and which was moving at a speed of 30 ft/min. The coated web was dried continuously by moving past perforated plates through which room temperature air flowed. The pressure drops across the perforated plates were in the range of 0.8 to 3 in H₂O. The air dew point ranged from 7 to 13° C. The resulting dry image-receiving layer coating weights were 22.4, 33.6, and 44.3 g/m², respectively.

The coated films were evaluated as described above. Maximum optical densities were 3.231, 3.646, and 2.954, respectively. Haze values were 8.9%, 11.5%, and 14.8%, respectively.

### Example 10

A nominal 25 wt % alumina mix was prepared at room temperature by mixing 135 g of a 22 wt % aqueous solution of nitric acid and 6090 g of deionized water. To this mix, 2075 g of alumina powder (DISPERAL® HP-14) was added over 30 min. The pH of the mix was adjusted to 2.56 by adding an additional 39 g of the nitric acid solution. The mix was heated to 80° C. and stirred for 30 min. The mix was cooled to room temperature and held for gas bubble disengagement prior to use. The cooled mix had a pH of 3.40.

A nominal 22 wt % solids image-receiving coating mix was prepared at room temperature by mixing 1757 g of a 10 wt % aqueous solution of poly(vinyl alcohol) (CELVOL® 540), 8082 g of the nominal 25 wt % alumina mix, and 163 g of a 10 wt % aqueous solution of nonyl phenol, glycidyl polyether (Surfactant 10G). The mix was cooled to room temperature and held for gas bubble disengagement prior to use. The image-receiving coating mix had a viscosity of 53 cP at 40° C.

Coated films were prepared as in Example 9. The image-receiving layer coating mix was heated to 40° C. and was applied continuously at rates of 92, 139, and 185 g/min onto the under-layer coated web, which was at room temperature and which was moving at a speed of 30 ft/min. The coated web was dried continuously by moving past perforated plates through which room temperature air flowed. The pressure drops across the perforated plates were in the range of 0.8 to 3 in H₂O. The air dew point ranged from 7 to 13° C. The resulting dry image-receiving layer coating weights were 21.8, 32.5, and 43.6 g/m², respectively.

The coated films were evaluated as described above. Maximum optical densities were 2.892, 3.332, and 3.171, respectively. Haze values were 8.0%, 11.1%, and 14.5%, respectively.

### Example 11

A nominal 30 wt % alumina mix was prepared at room temperature by mixing 180 g of a 22 wt % aqueous solution of nitric acid and 5420 g of deionized water. Ta this mix, 2400 g of alumina powder (DISPERAL® HP-14) was added over 30 min. The pH of the mix was adjusted to 2.17 by adding an additional 58 g of the nitric acid solution. The mix was heated to 80° C. and stirred for 30 min. The mix was cooled to room temperature and held for gas bubble disengagement prior to use. The cooled mix had a pH of 2.96.

A nominal 26 wt % solids image-receiving coating mix was prepared at room temperature by mixing 2030 g of a 10 wt % aqueous solution of poly(vinyl alcohol) (CELVOL® 540), 7782 g of the nominal 30 wt % alumina mix, and 188 g of a 10 wt % aqueous solution of nonyl phenol, glycidyl polyether (Surfactant 10G). The mix was cooled to room temperature and held for gas bubble disengagement prior to use. The image-receiving coating mix had a viscosity of 114 cP at 40° C.

Coated films were prepared as in Example 9. The image-receiving layer coating mix was heated to 40° C. and was applied continuously at rates of 120, 130, 140, 150, and 160 g/min onto the under-layer coated web, which was at room temperature and which was moving at a speed of 30 ft/min. The coated web was dried continuously by moving past perforated plates through which room temperature air flowed. The pressure drops across the perforated plates were in the range of 0.8 to 3 in H₂O. The air dew point ranged from 7 to 13° C. The resulting dry image-receiving layer coating weights were 32.2, 35.5, 38.1, 40.9, and 44.1 g/m², respectively.

The coated films were evaluated as described above. Maximum optical densities were 2.656, 3.550, 3.402, 3.171, and 3.098, respectively. Haze values were 10.6%, 11.5%, 12.9%, 14.0%, and 14.8%, respectively.

### Example 12

Mixes and coated films were prepared using the procedure of Example 11. The image-receiving layer coating mix was heated to 40° C. and was applied continuously at rates of 80, 120, and 16 g/min onto the under-layer coated web, which was at room temperature and which was moving at a speed of 30 ft/min. The coated web was dried continuously by moving past perforated plates through which room temperature air flowed. The pressure drops across the perforated plates were in the range of 0.8 to 3 in H₂O. The air dew point ranged from 7 to 13° C. The resulting dry image-receiving layer coating weights were 22.1, 33, and 44.1 g/m², respectively.

The coated films were evaluated as described above. Maximum optical densities were 2.494, 3.611, and 3.238, respectively. Haze values were 7.4%, 10.7%, and 15.3%, respectively.

The invention has been described in detail with reference to particular embodiments, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A method comprising:
providing a first composition comprising alumina, nitric acid, and water, said first composition comprising at least about 25 wt % alumina and comprising a pH below about 3.09;
forming an alumina mix according to a method comprising heating the first composition; and
forming an image-receiving layer from a second composition comprising said alumina mix and at least one first water soluble or water dispersible polymer.

2. The method according to claim 1, further comprising forming an under-layer from a third composition comprising at least one second water soluble or water dispersible polymer and a borate or borate derivative.

3. The method according to claim 2, wherein said at least one second water soluble or water dispersible polymer comprises poly(vinyl alcohol).

4. The method according to claim 1, wherein the alumina comprises boehmite alumina.

5. The method according to claim 1, wherein said at least one first water soluble or water dispersible polymer comprises poly(vinyl alcohol).

6. The method according to claim 1, wherein said first composition comprises at least about 30 wt % alumina.

7. The method according to claim 1, wherein said pH is below about 2.73.

8. The method according to claim 1, wherein said pH is between about 2.17 and about 2.73.

9. The method according to claim 1, wherein the alumina mix comprises at least about 25 wt % solids.

10. The method according to claim 1, wherein the alumina mix comprises at least about 30 wt % solids.

11. The method according to claim 1, wherein said heating the first composition comprises heating the first composition to about 80° C.

12. A transparent ink-jet recording film comprising the image-receiving layer formed according to the method of claim 1.

13. The transparent ink-jet recording film of claim 11, further comprising an under-layer formed from a third composition comprising a second water soluble or water dispersible polymer and a borate or borate derivative.

14. The transparent ink-jet recording film of claim 13, wherein said at least one second water soluble or water dispersible polymer comprises poly(vinyl alcohol).

15. A method comprising printing on the transparent ink-jet recording film according to claim 12.
